(19) United States
(12) Patent Application Publication
(10) Pub. No.: US 2016/0301997 A1
(43) Pub. Date: Oct. 13, 2016

(54) ELECTRONIC DEVICE

(71) Applicant: Panasonic Intellectual Property Management Co., Ltd., Osaka (JP)

(72) Inventors: Kenichi SHINDO, Osaka (JP); Takeshi MORI, Osaka (JP); Akira IWAMOTO, Osaka (JP)

(21) Appl. No.: 15/190,761

(22) Filed: Jun. 23, 2016

Related U.S. Application Data
(63) Continuation of application No. PCT/JP2014/004227, filed on Aug. 19, 2014.

(30) Foreign Application Priority Data
Dec. 25, 2013 (JP) 2013-267406

(51) Int. Cl. H04R 1/02; G06F 1/16; H04R 1/32

(52) U.S. Cl. CPC H04R 1/028; H04R 1/323; G06F 1/1626; G06F 1/1688; H04R 2499/11

(57) ABSTRACT

An electronic device according to the present disclosure includes a speaker. The electronic device includes an inner case that accommodates the speaker, and an outer case that accommodates the inner case, the outer case having therein an opening, or a gap between the outer case and a member adjacent thereto. A predetermined space is formed between the inner case and the outer case. A communicating portion connecting a space inside the inner case and the predetermined space is provided at a position close to the speaker in the inner case. The gap or the opening connects with the predetermined space.

### CROSS-REFERENCE TO RELATED APPLICATIONS

This is a continuation application of International Application No. PCT/JP2014/004227, with an international filing date of Aug. 19, 2014, which claims priorities of Japanese Patent Application No.: 2013-267406 filed on Dec. 25, 2013, the content of which is incorporated herein by references.

### BACKGROUND

1. Technical Field

The present disclosure relates to an apparatus including a speaker.

2. Related Art

An electronic device sometimes has a speaker. For example, electronic devices each having a speaker are described in JP-A-2008-211519 and JP-A-2011-101298.

JP-A-2008-211519 discloses a configuration to output a sound output from a speaker disposed in a case to the outside of the case through a sound releasing opening formed on the case.

JP-A-2011-101298 discloses a configuration to output a sound output from a speaker disposed in a case to the outside of the case through a gap between two members constituting a side face of the case.

### SUMMARY

There is a case that the electronic device includes an inner case accommodating electronic parts and so on, and an outer case accommodating the inner case, and the speaker may be accommodated in the inner case.

The present disclosure provides a sound releasing structure of an electronic device that includes an inner case accommodating a speaker and so on, and an outer case accommodating the inner case.

An electronic device according to the present disclosure includes a speaker. The electronic device includes an inner case that accommodates the speaker, and an outer case that accommodates the inner case, the outer case having therein an opening, or a gap between the outer case and a member adjacent thereto. A predetermined space is formed between the inner case and the outer case. A communicating portion connecting a space inside the inner case and the predetermined space is provided at a position close to the speaker in the inner case. The gap or the opening connects with the predetermined space.

According to the electronic device of the present disclosure, a sound output from the speaker can be transmitted from a space in the inner case to the predetermined space outside the inner case through the communicating portion, and can be output from the predetermined space to the outside of the outer case through, for example, the opening or the gap of the outer case.

### BRIEF DESCRIPTION OF DRAWINGS

FIG. 1 is a perspective view of an upper face (a display face) of a tablet terminal apparatus according to an embodiment of the present disclosure.

FIG. 2 is a perspective view of a lower face (a back face) of the tablet terminal apparatus according to the embodiment of the present disclosure.

FIG. 3 is a perspective view of the upper face (the display face) of the tablet terminal apparatus according to the embodiment of the present disclosure of which glass plate is removed and of which portion of a side face member of an outer cover is removed.

FIG. 4 is a cross-sectional view taken along an A-A line of FIG. 1.

FIG. 5 is a cross-sectional view taken along a B-B line of FIG. 1.

FIG. 6 is a perspective view of the tablet terminal apparatus according to the embodiment of the present disclosure seen in a direction of an arrow C of FIG. 3.

### DETAILED DESCRIPTION OF PREFERRED EMBODIMENT

### First Embodiment

An embodiment will be described in detail with arbitrary reference to the drawings. No description however may be made that is more detailed than necessary. For example, no detailed description of already well known items and no repeated description for substantially same configurations may be made. This is to avoid unnecessary redundancy of the following description and is to facilitate the understanding by those skilled in the art.

The inventor(s) provide(s) the accompanying drawings and the following description for those skilled in the art to sufficiently understand the present disclosure, and do(es) not intend to limit the subject matter described in claims by the drawings and the description.

In the following description, terms each meaning a specific direction (for example, “above”, “under”, “left”, “right”, and other terms including anyone of these) maybe used while the use of those terms is to facilitate the understanding of the present disclosure with reference to the drawings, and the present disclosure should not be interpreted being limited by the meaning of each of those terms.

The embodiment of the present disclosure described below takes an example of application to a what-is-called tablet-type portable information terminal apparatus (hereinafter, arbitrarily, referred to as “tablet terminal apparatus” or simply as “apparatus”). The tablet terminal apparatus includes a CPU, a storing device such as a RAM, a ROM, or an SSD, an input unit, and various types of external interface, and realizes predetermined functions by arithmetic processing by the CPU based on programs stored in the storing apparatus.

### 1. Configuration

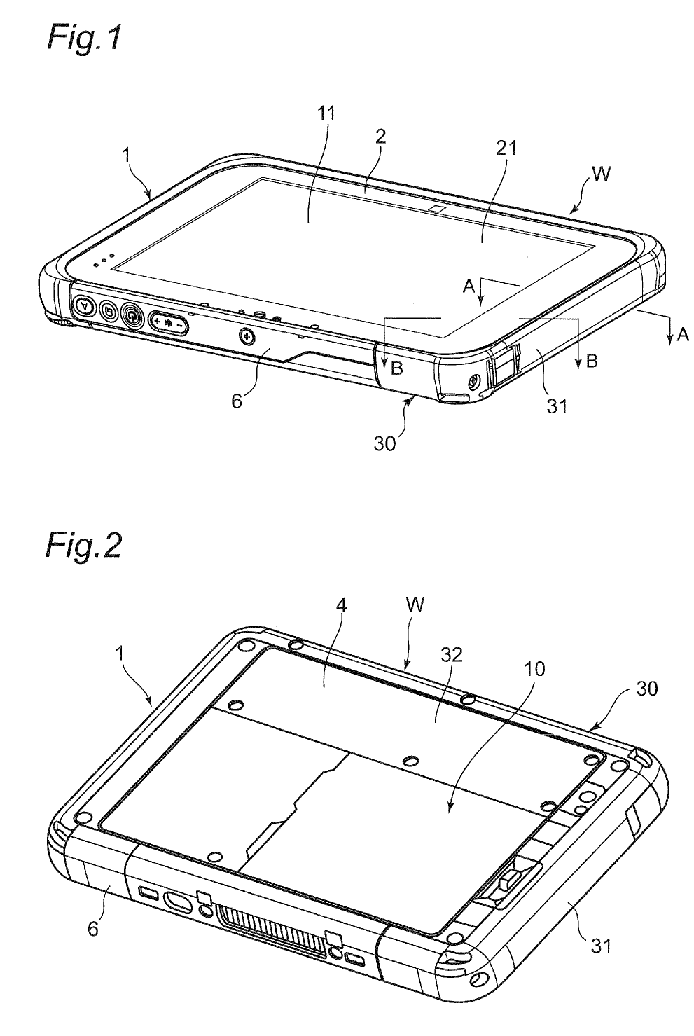

FIG. 1 is a perspective view of an upper face (a display face) of the tablet terminal apparatus as the electronic device according to this embodiment. FIG. 2 is a perspective view of a lower face (a back face) of the tablet terminal apparatus.

As depicted in FIGS. 1 and 2, the tablet terminal apparatus W according to this embodiment is formed to have a substantially rectangular shape and has a predetermined thickness (height). A glass plate 21 is disposed on the upper face portion 2 of the tablet terminal apparatus W. A display member 11 is disposed on the lower face of the glass plate 21. The display member 11 is a liquid crystal displaying device, for example. The display member 11 may be a touch panel displaying apparatus enabling a user to perform touch input. A battery pack 10 is mounted on the lower face portion 4 (the back side) of the tablet terminal apparatus W. The battery pack 10 is provided detachably according to a user operation on the battery lock operating member. Various operation switches and various connectors are disposed on a side face portion 6 of the tablet terminal apparatus W.

The tablet terminal apparatus W includes as a housing 1 an outer case 30 constituting an outer face thereof except the upper face portion constituted by the glass plate 21. The outer case 30 includes a side face member 31 constituting the side face portion 6 and a lower face member 32 constituting the lower face portion 4. The side face member 31 has a frame-like shape in a planar view thereof. The members constituting the outer case 30 are made from, for example, a resin such as, for example, elastomer.

As depicted in FIG. 4, an inner case 40 is accommodated in an inner space surrounded by the outer case 30 and the glass plate 21. The inner case 40 is configured to have a box-like shape to be able to accommodate various electronic parts. The inner case 40 includes an upper member 41 disposed on the glass plate 21 side, and a lower member 42 disposed on the opposite side of the glass plate 21. The inner case 40 constitutes the frame (framework material) of the tablet terminal apparatus W, and is formed using a metal material such as, for example, magnesium (Mg) to secure the mechanical rigidity and so on. In the following description, the upper member 41 and the lower member 42 will not be distinguished from each other and will be described as the inner case 40.

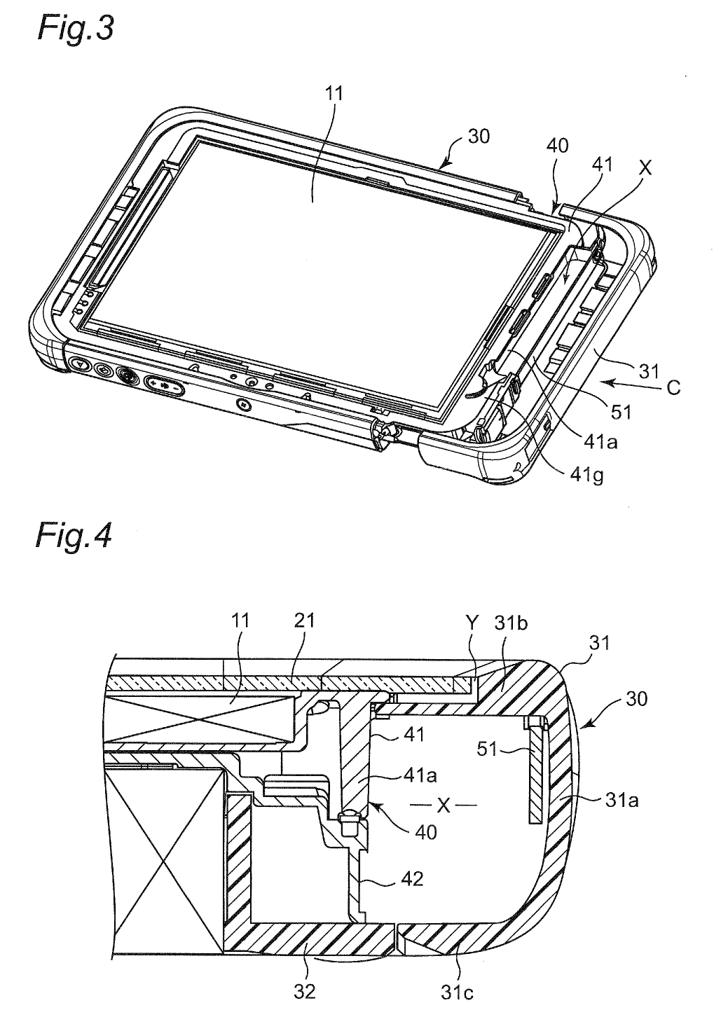

As depicted in FIG. 3, a recess portion 41a is formed on one side portion of the inner case 40 (a side portion in the lower right in FIG. 3) by recessing a portion of the one side portion in a longitudinal direction of the terminal apparatus W in a direction to get away by a predetermined length from a side portion of the outer case 30 (the side face member 31) corresponding to the one side portion of the inner case 40. As depicted in FIG. 4, this recess portion 41a forms a space X between the inner case 40 and the outer case 30. This space X is formed for disposing an antenna 51 for radio communication therein. The space X will hereinafter be referred to as “antenna disposition space X”.

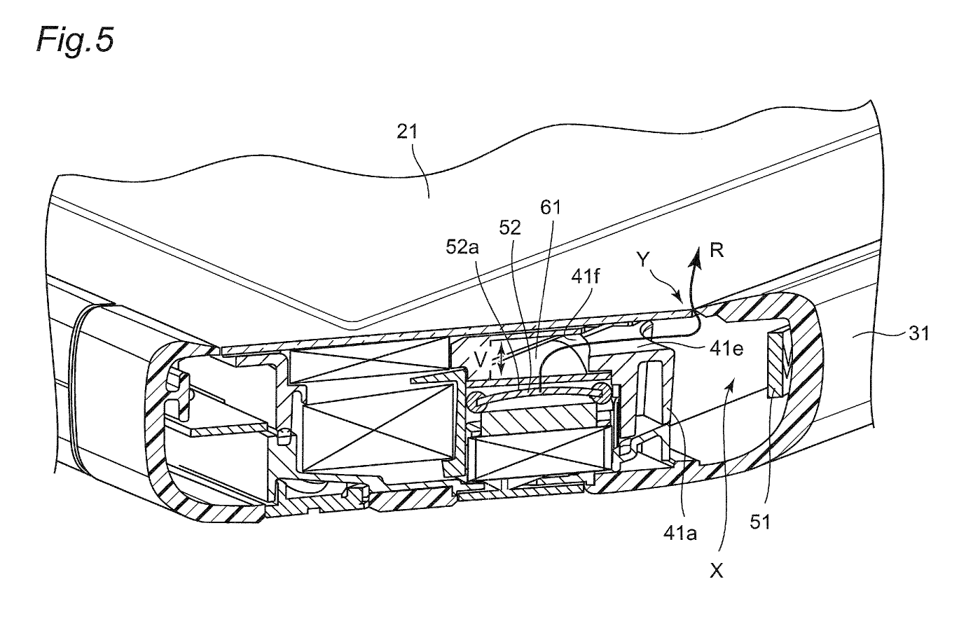

As depicted in FIG. 5, in the tablet terminal apparatus W of this embodiment, a speaker 52 to produce a sound is disposed in the inner case 40. A configuration will be described below to output the sound produced by the speaker 52 to the outside of the tablet terminal apparatus W.

The speaker 52 is disposed at a position in the vicinity of the antenna disposition space X in the inner case 40. Concretely, the speaker 52 is disposed in the vicinity of the recess portion 41a of the inner case 40 on the inner side of a portion 41g not having the recess portion 41a formed thereon in the one side portion of the inner case 40. The speaker 52 is disposed such that a vibration direction V of a vibrating plate 52a is a direction perpendicular to the glass plate 21.

As depicted in FIG. 4, the side face member 31 of the outer case 30 includes a side wall portion 31a, an upper wall portion 31b extending substantially perpendicularly to the side wall portion 31a from the upper end of the side wall portion 31a, and a lower wall portion 31c extending substantially perpendicularly to the side wall portion 31a from the lower end of the side wall portion 31a, and has a cross section formed into a substantially U-shape. A gap Y having a predetermined length is provided between an end of the upper wall portion 31b of the side face member 31 and an end of the glass plate 21 disposed adjacent to the upper wall portion 31b of the outer case 30.

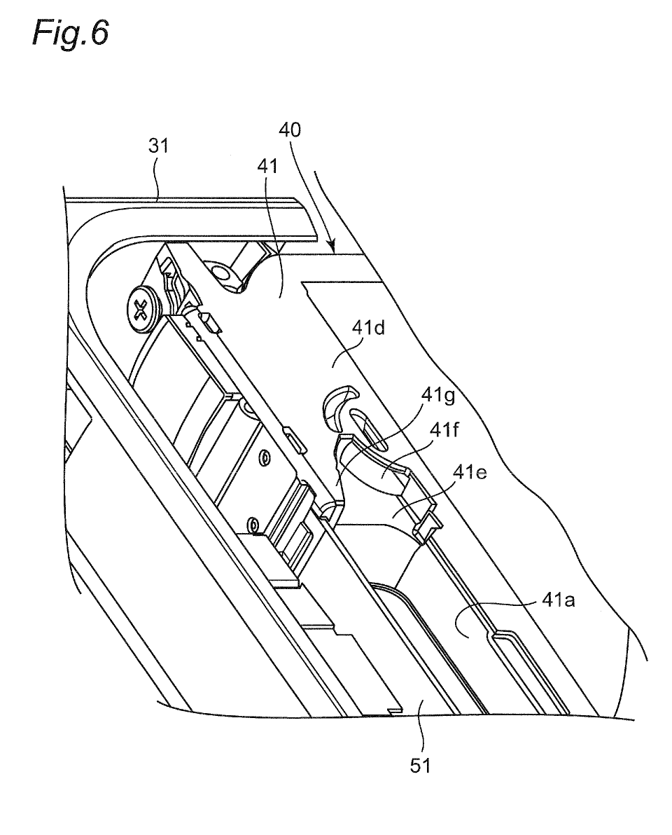

A communicating portion (a communicating hole 41f and a communicating groove 41e) connecting the inside of the inner case 40 with the antenna disposition space X is provided at a position close to the speaker 52 in the inner case 40. Concretely, as depicted in FIG. 6, the inner case 40 has an upper wall portion 41d on the main face of the glass plate 21 in parallel thereto, and the speaker 52 is disposed on the lower face side of the upper wall portion 41d. The speaker 52 is disposed in a space inside the certain portion 41g not having the recess portion 41a formed thereon in the one side portion of the inner case 40. The communicating hole 41f is disposed at a position facing the speaker 52 in the upper wall portion 41d. The communicating groove 41f is disposed that connects the communicating hole 41f and the antenna disposition space X to each other, on an upper face of the upper wall portion 41d (a face facing the glass plate 21). The communicating hole 41f guides the sound output from the speaker 52 in a direction substantially perpendicular to the main face of the glass plate 21, and the communicating groove 41e guides the sound output from the communicating hole 41f in a direction in parallel to the main face of the glass plate 21.

A waterproof sheet 61 preventing entrance of any water from the communicating hole 41f is attached to the other face of the upper wall portion 41d. A sheet of a material capable of transmitting a sound is used as the waterproof sheet 61.

According to this embodiment, as depicted in an arrow R in FIG. 5, the sound output from the speaker 52 is guided to the antenna disposition space X through the communicating hole 41f and the communicating groove 41e and is output from the antenna disposition space X to the outside of the tablet terminal apparatus W through the gap Y between the outer case 30 and the glass plate 21. At this time, the antenna disposition space X is usable as a space to reverberate the sound output from the speaker 52.

### 2. Conclusion

The tablet terminal apparatus W of this embodiment has the speaker 52. The tablet terminal apparatus W includes the inner case 40 accommodating the speaker 52, and the outer case 30 accommodating the inner case 40 and having the gap Y between the outer case 30 and the glass plate 21. The antenna disposition space X is formed between the inner case 40 and the outer case 30. The communicating portion (the communicating hole 41f and the communicating groove 41e) connecting the space inside the inner case 40 with the antenna disposition space X is provided at the position close to the speaker 52 in the inner case 40. The gap Y between the outer case 30 and the glass plate 21 adjacent thereto, connect with the antenna disposition space X.

With this configuration, the sound output from the speaker 52 can be transmitted from the space inside the inner case 40 to the antenna disposition space X outside the inner case 40 through the communicating portion (the communicating hole 41f and the communicating groove 41e), and can be output from the antenna disposition space X to the outside of the outer case 30 through, for example, the gap Y between the outer case 30 and the glass plate 21.

In this embodiment, the speaker 52 is disposed at the position in the vicinity of the antenna disposition space X in the inner case 40.

With this configuration, it can be prevented from losing of the sound produced by the speaker 52 until the sound reaches the antenna disposition space X and the external space of the tablet terminal apparatus W.

In this embodiment, the antenna disposition space X is formed by recessing the portion of the one side portion of the inner case 40 in a direction to get away from the outer case 30, and the communicating portion (the communicating hole 41f and the communicating groove 41e) is formed on the portion 41g except the certain portion in the one side portion.

With this configuration, the communicating portion (the communicating hole 41f and the communicating groove 41e) can be formed using the portion 41g except the certain portion in the one side portion of the inner case 40.

In this embodiment, the antenna 51 is disposed in the antenna disposition space X.

With this configuration, the antenna disposition space X is usable as the space to reverberate the sound output from the speaker 52.

In this embodiment, the glass plate 21 is disposed on the main face of the outer case 30, and the speaker 52 is disposed such that the vibration direction V of the vibrating plate 52a is perpendicular to the main face of the glass plate 21. The communicating portion (the communicating hole 41f and the communicating groove 41e) is formed to guide the sound output from the speaker 52 in the direction in parallel to the main face of the glass plate 21 and to output the sound to the antenna disposition space X.

With this configuration, the sound output from the speaker 52 can excellently be guided in the direction of the glass plate 21 along which the gap Y is present.

In this embodiment, the glass plate 21 is disposed on the main face of the outer case 30, and the gap Y is provided between the outer case 30 and the glass plate 21.

With this configuration, the sound can be output to the external space of the tablet terminal apparatus W through the gap Y between the outer case 30 and the glass plate 21.

### Other Embodiments

As above, the first embodiment has been described as an example of the technique disclosed in this application. The technique in the present disclosure is however not limited to this and is applicable to an embodiment to which a change, replacement, addition, omission, etc., are arbitrarily made.

This embodiment is configured for the sound output from the speaker 52 to be output to the external space of the tablet terminal apparatus W through the gap Y between the outer case 30 and the glass plate 21. The configuration however is not limited to this. For example, a configuration may be employed to include a penetrating hole disposed in the outer case 30 to pass through the antenna disposition space X and the external space of the tablet terminal apparatus W such that the sound output from the speaker 52 is output to the external space of the tablet terminal apparatus W through the penetrating hole.

In this embodiment, the case is described where the electronic device is the tablet terminal apparatus. The electronic device is however not limited to this. The present disclosure is applicable widely to electronic devices such as a notebook computer, an electronic notebook, and an electronic gaming machine.

As above, the embodiments have been described as examples of the technique in the present disclosure. To do this, the accompanying drawings and the detailed description have been provided.

The components depicted in the accompanying drawings and described in the detailed description may therefore include not only the components essential for solving the problem but also the components not essential for solving the problem to exemplify the technique. It should not therefore be readily recognized that those non-essential components are essential based on the fact that those non-essential components are depicted in the accompanying drawings and described in the detailed description.

The embodiments are to exemplify the technique in the present disclosure and various changes, replacements, additions, omissions, etc., can therefore be made to the embodiments within the scope of claims or a scope equivalent thereto.

### INDUSTRIAL APPLICABILITY

The present disclosure is applicable widely to portable electronic devices such as a notebook computer, a tablet computer, an electronic notebook, and an electronic gaming machine. Explanations of Letters or Numerals

1. An electronic device comprising a speaker, comprising:
an inner case that accommodates the speaker; and
an outer case that accommodates the inner case, the outer case having therein an opening, or a gap between the outer case and a member adjacent thereto, wherein
a predetermined space is formed between the inner case and the outer case,
a communicating portion connecting a space inside the inner case and the predetermined space is provided at a position close to the speaker in the inner case, and
the gap or the opening connects with the predetermined space.

2. The electronic device of claim 1, wherein
the speaker is disposed at a position in a vicinity of the predetermined space in the inner case.

3. The electronic device of claim 1, wherein
the predetermined space is formed by recessing a portion of one side portion of the inner case in a direction getting away from the outer case, and wherein
the communicating portion is formed in a portion except the certain portion in the one side portion.

4. The electronic device of claim 1, wherein
an antenna is disposed in the predetermined space.

5. The electronic device of claim 1, wherein
a glass plate is disposed on a main face of the outer case, wherein
the speaker is disposed such that a vibration direction of a vibrating plate thereof is perpendicular to a main face of the glass plate, and wherein
the communicating portion is formed to guide a sound output from the speaker in a direction in parallel to the main face of the glass plate and to output the sound to the predetermined space.

6. The electronic device of claim 1, wherein
the glass plate is disposed on the main face of the outer case, wherein
the gap is provided between the outer case and the glass plate.

7. The electronic apparatus of claim 1, wherein
the electronic device is a tablet computer.
